(19) United States
(12) Patent Application Publication
(10) Pub. No.: US 2025/0260025 A1
(43) Pub. Date: Aug. 14, 2025

(54) ELECTROCHEMICAL CELL HAVING A MEMBRANE-ELECTRODE UNIT, A DIFFUSION LAYER AND A DISTRIBUTOR PLATE, AND A METHOD FOR PRODUCING AN ELECTROCHEMICAL CELL

(71) Applicant: Robert Bosch GmbH, Stuttgart (DE)

(72) Inventors: Andreas Ringk, Bamberg (DE); Anton Ringel, Bamberg (DE)

(21) Appl. No.: 18/706,061

(22) PCT Filed: Oct. 13, 2022
(86) PCT No.: PCT/EP2022/078476

§ 371 Date: Apr. 30, 2024

(30) Foreign Application Priority Data
Nov. 3, 2021 (DE) 10 2021 212 400.3

(51) Int. Cl. H01M 8/0286; C25B 9/23; C25B 13/02; H01M 8/0258; H01M 8/0273; H01M 8/10; H01M 8/1004

(52) U.S. Cl. CPC H01M 8/0286; C25B 9/23; C25B 13/02; H01M 8/0258; H01M 8/0273; H01M 8/1004; H01M 2008/1095

(57) ABSTRACT

The invention relates to an electrochemical cell (100) having a membrane electrode unit (1), a diffusion layer (5) and a distributor plate (7, 20). The membrane electrode unit (1) has a frame structure (16), wherein the frame structure (16) has a film (161) which is adhesively bonded to a membrane (2) by means of an adhesive (163). The diffusion layer (5) and the distributor plate (7, 20) partially contact the film (161). The film (161) has at least one first recess (161a) and at least one second recess (161b). The adhesive (163) is arranged in the two recesses (161a, 161b) such that it forms a connection to the diffusion layer (5, 6) lying thereabove via the first recess (161a) and forms a connection to the distributor plate (7, 8, 20) lying thereabove via the second recess (161b).

### BACKGROUND

The present invention relates to an electrochemical cell, in particular a fuel cell, having a membrane electrode unit, a diffusion layer and a distributor plate. The invention further relates to a method for producing such an electrochemical cell.

Fuel cells are electrochemical energy converters, in which hydrogen and oxygen are converted into electrical energy and water, for example. Fuel cells or fuel cell stacks are constructed of multi-part cells, which alternately comprise membrane electrode units and bipolar plates arranged on top of each other. The bipolar plates are used to supply educts to the electrodes and cool the fuel cell stack. The bipolar plates have a distribution structure for this purpose, which guide educt-containing fluids along the electrodes; a bipolar plate is in this case typically comprised of two distributor plates. In addition, the distributor structures serve to guide a cooling fluid along the further distributor structures or within the bipolar plate. The distributor structures are typically formed as channels, thereby allowing the different fluids to be conducted.

A specific fuel cell type is the polymer electrolyte membrane fuel cell (PEM-FC). In an active region of a PEM-FC, two porous electrodes having a catalyst layer abut on a polymer electrolyte membrane (PEM). In the active region, the PEM-FC further comprises gas diffusion layers (GDL) which border, on both sides, the polymer electrolyte membrane (PEM) and the two porous electrodes having a catalyst layer. The PEM, the two electrodes having the catalyst layer, and optionally also the two GDL can form what is referred to as a membrane electrode unit (MEA) in the active region of the PEM-FC. Two opposing bipolar plates (halves) in turn border the MEA on both sides. A fuel cell stack is constructed of MEAs and bipolar plates alternately arranged one above the other. Using an anode plate of a bipolar plate, a distribution of the fuel, in particular hydrogen, takes place, and using a cathode plate of the bipolar plate, a distribution of the oxidizing agent, in particular air/oxygen, takes place. In order to electrically isolate adjacent bipolar plates, in order to stabilize the shape of the MEA, and in order to prevent unwanted escape of the fuel or of the oxidizing agent, the MEA can be enclosed in a frame-like opening of two films arranged on one another. Typically, the two films of this frame structure are made of the same material, e.g., polyethylene naphthalate (PEN). The two films made of the same material can have dispensably redundant properties, e.g. an electrical insulating capability (electrically insulating), and/or an oxygen-tightness of each of the two films.

A fuel cell having two bipolar plates is known from DE 10 2005 058 370 A1, in which a membrane electrode unit is arranged between the bipolar plates, and a diffusion layer is arranged between the membrane electrode unit and the bipolar plates. The membrane electrode unit is in this case arranged on a carrier frame or a frame structure. An ultrasonic weld joint is formed between the membrane electrode unit and the frame structure, via which the membrane electrode unit is connected to the frame structure.

It is also known from the prior art that the frame structure is directly connected to the bipolar plate via an ultrasonic weld connection. A laser-made weld joint can also be used instead of the ultrasonic weld joint. Although these methods have the advantage that no additional material is needed, a rough surface is still necessary.

DE 101 40 684 A1 discloses a membrane electrode unit for a fuel cell, containing a layer arrangement consisting of an anode electrode, a cathode electrode, and a membrane arranged between them, whereby a polymeric material is applied to an upper and a lower side of the layer arrangement.

### SUMMARY

The object of the present invention is to provide a method for attaching a frame structure having a diffusion layer and a distributor plate or bipolar plate, in which the frame structure can be connected to the diffusion layer and the distributor plate in a simple and economical manner in order to save material. The invention is also intended to comprise a corresponding electrochemical cell.

To this end, the electrochemical cell comprises a membrane electrode unit, a diffusion layer, and a distributor plate. The membrane electrode unit has a frame structure, whereby the frame structure has a film which is adhesively bonded to a membrane by means of an adhesive. The diffusion layer and the distributor plate partially contact the film. The film has at least one first recess and at least one second recess. The adhesive is arranged in the two recesses such that it forms a connection to the diffusion layer lying thereabove via the first recess and forms a connection to the distributor plate lying thereabove via the second recess.

The membrane electrode unit preferably comprises a flat membrane, in particular a polymer electrolyte membrane (PEM). The membrane electrode unit can further comprise two preferably porous electrode layers each having a catalyst paste, whereby said electrode layers are in particular arranged on the membrane and border it on both sides. This unit can in particular be referred to as an MEA-3. The membrane electrode unit can further comprise two diffusion layers. These diffusion layers can in particular border the MEA-3 on both sides. This unit can in particular be referred to as an MEA-5.

The invention also comprises a method for producing such an electrochemical cell. The method comprises the following method steps:
placing the diffusion layer on the frame structure such that the film contacts the first recess at the diffusion layer,
connecting the frame structure to the diffusion layer by melting the adhesive in the area of the first recess using a hot punch and pushing the adhesive into the first recess,
placing the frame structure on the distributor plate such that the film contacts the second recess on the distributor plate,
connecting the frame structure to the distributor plate by melting the adhesive in the area of the second recess using a hot punch and pushing the adhesive into the second recess.

One or a plurality of hot punches can be used for the method steps. A recess in the sense of the present invention is in particular understood to mean a breakthrough through a film, which allows the adhesive to be connected to the distributor plate or the diffusion layer. Preferably, this connection is achieved by means of an easy to perform hot punching step. In addition, the adhesive only has to be provided in the area of the recesses. As a result, little adhesive is required for attaching the frame structure to the diffusion layer and to the bipolar plate. Accordingly, only a small amount of additional material is needed. In addition, such a method is thus simple and economically feasible. The assembly of the electrochemical cell resulting therefrom is ideally suited for a stacking process of multiple electrochemical cells into a cell stack.

In an advantageous embodiment of the electrochemical cell, its frame structure comprises a further film. The film is connected to the further film by the adhesive. As a result, the adhesive is also used for connecting the two films, i.e., it is already present. Thus, no additional step is needed to apply the adhesive; the existing adhesive only needs to be melted in order to then also connect the diffusion layer and the distributor plate to the frame structure.

The further film advantageously has at least one third recess, whereby the adhesive is arranged in the third recess such that it forms a connection to a further diffusion layer lying thereabove via the third recess.

The two films are thus connected to each other by the adhesive. The same adhesive is arranged in this area by the recesses. The frame structure is connected to the two diffusion layers and the distributor plate via this adhesive. Since the adhesive for connecting the two films has already been applied, no additional material is needed for connecting the frame structure to the diffusion layers and to the distributor plate. As a result, such a method can be performed simply and economically.

In advantageous embodiments, the first recess has a lateral offset when viewed in a stacking direction from the third recess. As a result, the adhesive in the first and third recesses need not be hot stamped over one another. Furthermore, sufficient adhesive is thus present for both the first and the third recess, as the recesses are thus filled with adhesive from different areas.

Preferably, the second recess is formed in a remaining area, whereby the distributor plate projects beyond the diffusion layer in the remaining area. As a result, the diffusion layer and the distributor plate can thus be attached to the frame structure virtually side by side.

In a further preferred embodiment of the invention, the adhesive is a UV adhesive so that the UV adhesive is cured using a UV source. Preferably, at least the film is in this case permeable to UV light so that the adhesive can be cured using a UV source. As a result of this method step, the frame structure can be connected to the diffusion layer or to the distributor plate at a specific time, so that further correction of the position is possible. In addition, curing via UV light enables easy and controlled attachment.

Preferably, the adhesive is a hot glue, so that the films are connected together by a laminate process. A hot glue is in this case an adhesive that transitions to an adhesive state when exposed to heat. As a result of such a method step, it is possible to easily connect the two films to each other via heating, for example hot stamping. In the laminar process, the two films are preferably connected at a temperature of 100-200° C. and a pressure of 0.5-5 MPa; the same applies to the connection of the frame structure to the diffusion layer and to the distributor plate.

For example, the electrochemical cell can be a fuel cell, an electrolysis cell, or a battery cell. The fuel cell is in particular a PEM-FC (polymer electrolyte membrane fuel cell). In particular, a cell stack comprises a plurality of electrochemical cells arranged one above the other.

### BRIEF DESCRIPTION OF THE DRAWINGS

Exemplary embodiments of the invention are shown in the drawings and explained in more detail in the subsequent description. Shown are:

FIG. 1 a section through a schematic electrochemical cell, whereby only the essential domains are shown,

FIG. 2 a vertical section of a membrane electrode assembly, in which only the essential areas are shown,

FIG. 3 a vertical section of a membrane electrode assembly, in which only the essential areas are shown,

FIG. 4 a vertical section of a membrane electrode assembly according to the invention, in which only the essential areas are shown,

FIG. 5 an exploded perspective diagram of a schematic process flow for producing an electrochemical cell,

FIG. 6 method steps, by way of example, for attaching a frame structure on a bipolar plate by means of a hot punch.

### DETAILED DESCRIPTION

FIG. 1 schematically shows an electrochemical cell 100 known from the prior art in the form of a fuel cell, in which only the essential regions are shown. The fuel cell 100 comprises a membrane 2, in particular a polymer electrolyte membrane. To one side of the membrane 2 a cathode space 100a is formed, to the other side an anode space 100b.

In the cathode space 100a, outwardly facing from the membrane 2—therefore in the normal direction or stacking direction z—an electrode layer 3, a diffusion layer 5, and a distributor plate 7 are arranged. An electrode layer 4, a diffusion layer 6, and a distributor plate 8 are in a similar manner arranged in the anode space 100b facing outwardly from the membrane 2. The membrane 2 and the two electrode layers 3, 4 form a membrane electrode assembly 1. Furthermore, the two diffusion layers 5, 6 can also be a component of the membrane electrode assembly 1.

The distributor plates 7, 8 have channels 11 for the gas supply—for example air in the cathode space 100a and hydrogen in the anode space 100b—to the gas diffusion layers 5, 6. The diffusion layers 5, 6 typically consist of a carbon fiber fleece on the channel side—i.e., towards the distributor plates 7, 8—and a microporous particle layer on the electrode side—i.e., towards the electrode layers 3, 4.

The distributor plates 7, 8 comprise the channels 11 and thus implicitly also connecting portions 12 adjacent to the channels 11. The undersides of these connecting portions 12 thus form a contact surface 13 of the respective distributor plate 7, 8 to the underlying diffusion layer 5, 6.

The cathode-side distributor plate 7 and anode-side distributor plate 8 conventionally differ from each other. Preferably, the cathode-side distributor plate 7 of an electrochemical cell 100 and the anode-side distributor plate 8 of the electrochemical cell adjacent thereto are fixedly connected, for example by welded connections, and thus combined into a bipolar plate.

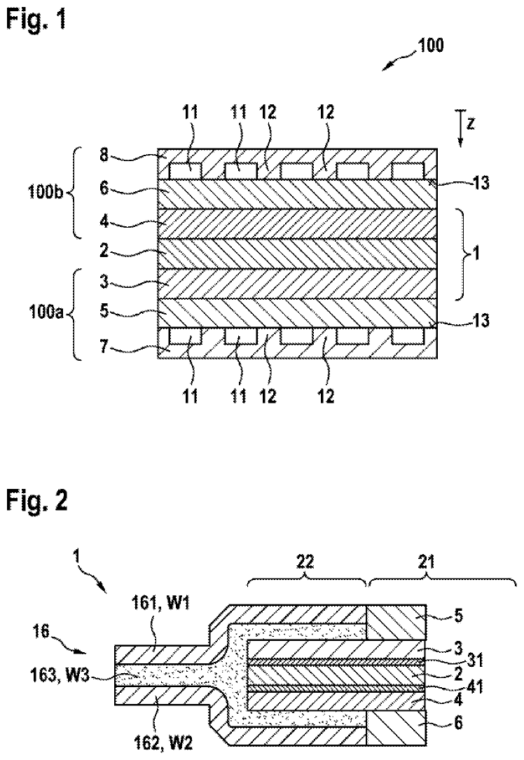

FIG. 2 shows a vertical section of the membrane electrode assembly 1 of an electrochemical cell 100, in particular of a fuel cell, in an edge region, in which only the essential regions are shown. The membrane electrode assembly 1 has the flat membrane 2, by way of example a polymer electrolyte membrane (PEM), and two porous electrode layers 3 and 4 each having a catalyst layer, whereby the electrode layers 3 and 4 are each arranged on one side or surface of the membrane 2. The electrochemical cell 100 further comprises the two gas diffusion layers 5 and 6 which, depending on the embodiment, can also belong to the membrane electrode assembly 1.

The membrane electrode assembly 1 is circumferentially surrounded by the frame structure 16, which in the present context is also referred to as a subgasket. The frame structure 16 is used to provide stiffness and tightness to the membrane electrode assembly 1 and is a non-active area of the electrochemical cell 100.

The frame structure 16 is in particular designed to be U-shaped or Y-shaped in section, a first leg of the U-shaped frame portion being formed by a film 161 made of a first material W1, and a second leg of the U-shaped frame portion being formed by a further film 162 made of a second material W2. In addition, the film 161 and the further film 162 are adhered together by means of an adhesive 163 made of a third material W3. The first material W1 and the second material W2 are often identical and made of a thermoplastic polymer, e.g., PEN (polyethylene naphthalate).

The two gas diffusion layers 5 or 6 are basically inserted into the frame structure 16, conventionally such that they are each in contact with one electrode layer 3, 4 via an active surface 21 of the membrane electrode assembly 1. The electrode layers 3, 4 each comprise a catalyst paste 31, 41 in which catalysts, typically catalyst particles, are embedded.

If the electrode layers 3, 4 are covered by the frame structure 16, then it is a non-active edge region 22 of the membrane electrode assembly 1. In the non-active edge region 22, then no reaction fluids reach the electrode layers 3, 4 or catalytic pastes 31, 41 of the embedded catalysts. As a result, chemical reactions do not take place in the edge region 22, and the current density of the electrochemical cell 100 thus drops very sharply relative to the active surface 21, or is even zero.

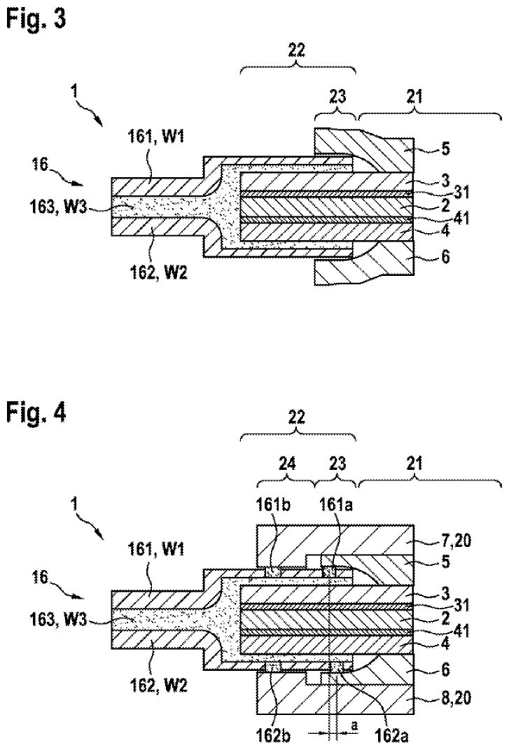

FIG. 3 shows a vertical section of a further membrane electrode assembly 1 of an electrochemical cell 100, in which only the essential regions are shown. The embodiment in FIG. 3 is similar to the embodiment of FIG. 2, but the two diffusion layers 5, 6 then overlap with the frame structure 16. As a result, the diffusion layers 5, 6 project into the edge region 22 and define an overlap region 23. In the overlap region 23, the following components of the membrane electrode assembly 1 are arranged from inward to outward as follows:
membrane 2,
electrode layers 3, 4 comprising catalyst pastes 31, 41,
adhesive 163,
film 161 and/or further film 162,
diffusion layers 5, 6.

FIG. 4 shows a membrane electrode unit 1 according to the invention in a vertical section, in which only the essential areas are shown. Like the exemplary embodiment in FIG. 3, the diffusion layers 5, 6 overlap with the frame structure 16 in the exemplary embodiment in FIG. 4 such that the overlap region 23 is created.

In the overlap region 23, the film 161 then has a first recess 161a and the further film 162 has a third recess 162a, through which the adhesive 163 penetrates and thus engages in an adhesive connection to the diffusion layer 5, 6 lying thereabove.

In the edge region 23, the distributor plates 7, 8 project beyond the diffusion layers 5, 6 thereunder; the distributor plates 7, 8 thus project beyond the overlap region 23. In the resulting residual area 24, the distributor plates 7, 8 can contact the frame structure 16 thereunder at least under the tension force of the mounted stack of cells. In the remaining area 24, the film 161 then has a second recess 161b and the further film 162 has a fourth recess 162b, through which the adhesive 163 penetrates and thus engages in an adhesive connection to the distributor plate 7, 8 lying thereabove.

Preferably, a cathode-side distributor plate 7 and the anode-side distributor plate 8 of the adjacent electrochemical cell 100 are connected to a bipolar plate, more preferably by means of welded connections.

So, the adhesive 163 not only connects the membrane 2 and the two electrode layers 3, 4 to the frame structure 16, but also the membrane electrode unit 1 thereby created to the diffusion layers 5, 6 and the distributor plates 7, 8, or to one or two bipolar plates 20.

In advantageous embodiments, the first recess 161a and the third recess 162a are at an offset a when viewed in the stacking direction z. This is particularly advantageous if the adhesive bonding is performed by means of a hot punch, because sufficient adhesive 163 is present on the individual recesses 161a, 162a, which can flow through the recesses 161a, 162a in the liquefied state and form a connection to the diffusion layer 5, 6 lying thereabove.

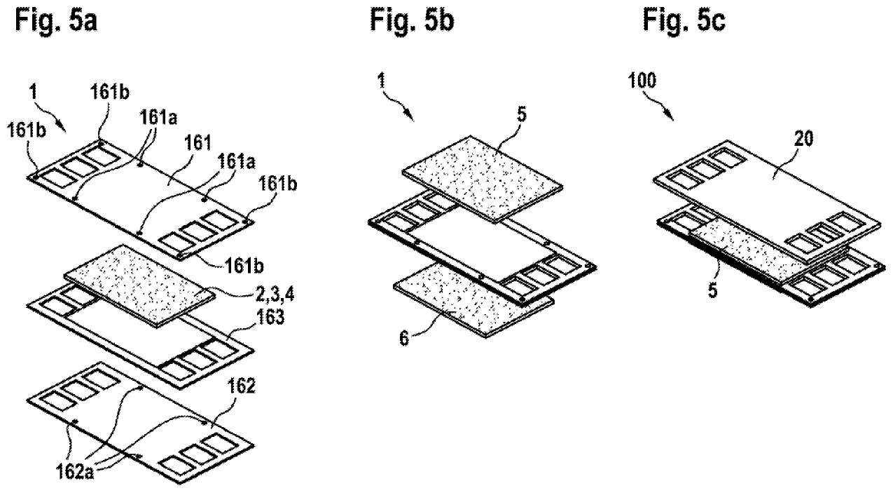

FIG. 5 schematically shows an exploded perspective view of a process flow for producing an electrochemical cell 100 having a membrane electrode unit 1 and a bipolar plate 20.

FIG. 5a shows the construction of the membrane electrode unit 1 comprising the membrane 2, the two electrode layers 3, 4, and the frame structure 16, which in turn comprises the film 161, the further film 162, and the adhesive 163 arranged therebetween. In the initial state, the adhesive 163 can in this case, e.g., initially also be applied to the two films 161, 162.

In the embodiment in FIG. 5a, the film 161 has four first recesses 161a and four second recesses 161b; the further film 162 only has four third recesses 162a, since an electrochemical cell 100 is to be produced using a membrane electrode assembly 1 and a bipolar plate 20.

FIG. 5b shows the connection of the membrane electrode assembly 1 to the two diffusion layers 5, 6. The connection is in this case preferably performed by hot stamping, whereby the adhesive 163 is melted in the areas of the first recesses 161a and the third recesses 162a, flows or pushes through these recesses 161a, 162a and is then adhesively bonds to the diffusion layers 5, 6 lying thereabove.

FIG. 5c shows the joining of the electrochemical cell 100 from the membrane electrode assembly 1 and the bipolar plate 20. For this purpose, the membrane electrode assembly 1 comprises a diffusion layer 5, 6 on both sides of the membrane 2. The connection of the bipolar plate 20 to the membrane electrode assembly 1 is in this case preferably performed by hot stamping, whereby the adhesive 163 is melted in the areas of the second recesses 161b, flows through these recesses 161b and then adhesively bonds to the bipolar plate 20 lying thereabove—or a distributor plate.

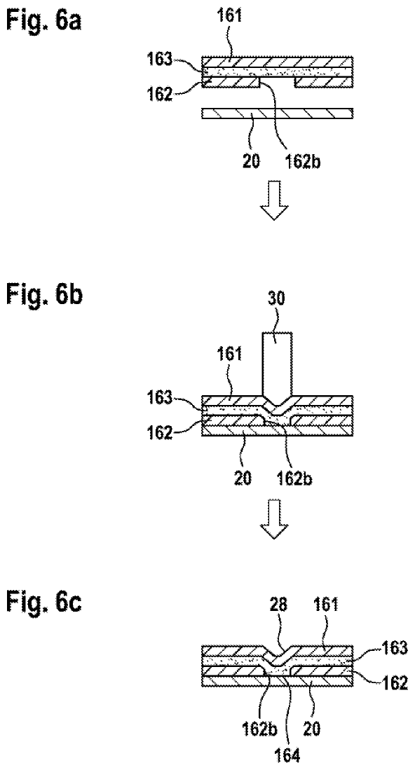

FIG. 6 shows the method steps for attaching the frame structure 16 on the bipolar plate 20 by means of a hot punch 30. In this embodiment, the frame structure 16 is connected to the bipolar plate 20 in an area in which the membrane 2 and the electrode layers 3,4 are no longer present. This drawing shows a section through a region of a fourth recess 162b. The adhesive 163 is intended to connect the membrane electrode unit 1 to the bipolar plate 20 on the second film 162. This is a virtually identical design for connecting the membrane electrode unit 1 to the bipolar plate 20 on the first film 161.

Section drawing 6a shows that the adhesive 163 is arranged between the first and the second film 161, 162, by means of which adhesive both films 161, 162 are connected to one another. In this exemplary embodiment, the adhesive 163 is a hot glue, by means of which both films 161, 162 are connected to one another by a laminate process. Due to the recess 162b, there is no connection of the two films 161, 162 in this area. Section drawing 6a shows the step before the membrane electrode unit 1 is placed on the bipolar plate 20.

In section drawing 6b, the step is shown in which an embossing step is performed by means of the hot punch 30. In this step, the further film 162 directly contacts the bipolar plate 20. The hot punch 30 is in this case positioned in the area of the recess 162b, imparts an embossing force on the film 161, and brings thermal energy in this area into the adhesive 163. The heated adhesive 163 is thus brought into contact with the bipolar plate 20. The hot punch 30 is thus heated so that the film 161 connects to the bipolar plate 20 via the adhesive 163 in the form of hot glue.

An embossed adhesive point 164 is therefore formed by the embossing step and is essentially determined by the shape of the recess 162b and the shape of the hot punch 30. Section drawing 6c shows the corresponding part of the membrane electrode assembly 1 after the hot punch 30 has been removed. In this case, it can be seen that a depression 28 in the first film 161 was formed by the embossing hot punch 30. This depression 28 extends into the recess 162b of the second film 162. As a result, the mechanical connection between both films 161, 162 is improved.

1. An electrochemical cell (100) having a membrane electrode unit (1), a diffusion layer (5) and a distributor plate (7, 20), wherein the membrane electrode unit (1) has a frame structure (16), wherein the frame structure (16) has a film (161) which is adhesively bonded to a membrane (2) by an adhesive (163), wherein the diffusion layer (5) and the distributor plate (7, 20) partially contact the film (161),
wherein
the film (161) has at least one first recess (161a) and at least one second recess (161b), wherein the adhesive (163) is arranged in the two recesses (161a, 161b) such that the adhesive (163) forms a connection to the diffusion layer (5, 6) lying thereabove via the at least one first recess (161a) and forms a connection to the distributor plate (7, 8, 20) lying thereabove via the at least one second recess (161b).

2. The electrochemical cell (100) according to claim 1, wherein the frame structure (16) has a further film, wherein the film (161) is connected to the further film (162) by the adhesive (163).

3. The electrochemical cell (100) according to claim 1, wherein the frame structure (16) has a further film, wherein the film (161) is connected to the further film (162) by the adhesive (163), wherein the further film (162) has at least one third recess (162a), wherein the adhesive (163) is arranged in the at least one third recess (162a) such that the adhesive (163) forms a connection to a further diffusion layer (6) lying thereabove via the at least one third recess (162a).

4. The electrochemical cell (100) according to claim 3, wherein, when viewed in a stacking direction (z), the at least one first recess (161a) is at a lateral offset (a) to the at least one third recess (162a).

5. The electrochemical cell (100) according to claim 1, wherein the at least one second recess (161b) is formed in a remaining area (24), wherein the distributor plate (7, 8, 20) projects beyond the diffusion layer (5, 6) in the remaining area (24).

6. A method for producing an electrochemical cell (100) having a membrane electrode assembly (1), a diffusion layer (5), and a distributor plate (7, 20), wherein the membrane electrode unit (1) comprises a frame structure (16), wherein the frame structure (16) has a film (161) which is adhesively bonded to a membrane (2) by an adhesive (163), wherein the film (161) comprises at least one first recess (161a) and at least one second recess (161b), said method comprising the following steps:
placing the diffusion layer (5) on the frame structure (16) such that the film (161) contacts the diffusion layer (5) comprising the at least one first recess (161a),
connecting the frame structure (16) to the diffusion layer (5) by melting the adhesive (163) in an area of the at least one first recess (161a) using a hot punch (30) and pushing the adhesive into the at least one first recess (161a),
placing the frame structure (16) on the distributor plate (7, 20) such that the film (161) contacts the at least one second recess (161b) on the distributor plate (7, 20),
connecting the frame structure (16) to the distributor plate (7, 20) by melting the adhesive (163) in an area of the at least one second recess (161b) using a hot punch (30) and pushing the adhesive into the at least one second recess (161b).

7. The method according to claim 6, wherein the adhesive (163) is a UV adhesive, so that the UV adhesive is cured using a UV source.

8. The electrochemical cell (100) according to claim 2, wherein the at least one second recess (161b) is formed in a remaining area (24), wherein the distributor plate (7, 8, 20) projects beyond the diffusion layer (5, 6) in the remaining area (24).

9. The electrochemical cell (100) according to claim 3, wherein the at least one second recess (161b) is formed in a remaining area (24), wherein the distributor plate (7, 8, 20) projects beyond the diffusion layer (5, 6) in the remaining area (24).
